(19) United States
(12) Patent Application Publication
(10) Pub. No.: US 2010/0064293 A1
(43) Pub. Date: Mar. 11, 2010

(54) APPARATUS AND METHOD FOR MANAGING USER SCHEDULE

(76) Inventors: Kyuchang KANG, Daejeon-city (KR); Yunkyung PARK, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/552,450

(22) Filed: Sep. 2, 2009

(30) Foreign Application Priority Data
Sep. 11, 2008 (KR) 10-2008-0089835

(51) Int. Cl. G06F 9/46; G06F 21/00

(52) U.S. Cl. 718/104; 726/2; 709/226; 718/1

(57) ABSTRACT

The present invention estimates a schedule of a user by collecting and analyzing information on a user-related work to be performed by accessing a schedule management program on the basis of corresponding user information when the user enters a region capable of using computing resources and executes a service application program that can perform the corresponding scheduled job through a virtual machine by automatically creating the virtual machine of a computing environment that can perform the estimated scheduled job. According to the present invention, a virtual machine is dynamically created so as to execute a work grasped as a work that the user must perform by analyzing a current schedule while access of the user and an application program for performing the corresponding work in the created virtual machine is automatically executed, such that user convenience is increased.

### RELATED APPLICATIONS

The present application claims priority to Korean Patent Application Serial Number 10-2008-0089835, filed on Sep. 11, 2008, the entirety of which is hereby incorporated by reference.

### BACKGROUND OF THE INVENTION

1. Field of the Invention

The present invention relates to an apparatus and a method for managing a user schedule that provides a computing environment capable of performing a job which a user must perform for schedule management by using a user schedule registered in a schedule management program and peripheral devices in the vicinity of the user.

2. Description of the Related Art

In general, free programs provided from a predetermined web site, which has a function of a memo pad type using a calendar executed on the Internet are primarily used in personal schedule information management. In recent years, additional functions in which the schedule management programs are synchronized with each other are provided, but the schedule management programs are not interlocked with a technology of providing a computing environment in which jobs such as a document job can dynamically be performed in accordance with the user schedule.

Recently, as the number of CPU cores of a computer increases, the resources that do not fully utilize the functions of the computer at the time of using the computer remain. In order to utilize the remaining resources, a virtualization technology is introduced and primarily utilized in a server-level computer. This tendency is also reflected to a personal computer and a virtual machine which several persons can use with one personal computer is created, such that a technology of providing a virtual environment in which each user uses each user's own computer is in full development.

In the computing environment, a method of setting a resource which the user intends to individually use by using a virtual machine monitor and creating a user's virtual machine is possible. However, since the user must allocate the resources in order to generate the user's virtual machine in the computing environment for performing the scheduled job, a system error may occur when a person who is not familiar with the computing environment sets a development use environment before a job. In particular, when different computing environments are required for each schedule, there is a problem in that the user must create the virtual machine whenever performing the corresponding scheduled job.

### SUMMARY OF THE INVENTION

There is an object of the present invention to provide an apparatus and a method for managing a user schedule that automatically create a virtual machine of a computing environment for performing a corresponding scheduled job to perform a corresponding user scheduled job through the virtual machine.

In order to achieve the object, according to an aspect of the present invention, an apparatus for managing a user schedule that manages a schedule of a user by receiving schedule information from a schedule management server includes: a schedule management unit that collects schedule information registered with respect to a corresponding user by accessing the schedule management server while access of the user and extracts information on a scheduled job to be performed; an execution environment management unit that determines a work environment for performing the corresponding scheduled job from the extracted schedule information and allocates resources in accordance with the determined work environment; and a processing unit that creates a user virtual machine for performing the scheduled job of the corresponding user in the work environment formed by using the resources allocated by the execution environment management unit.

The processing unit dynamically creates the user virtual machine in accordance with work environment determined by the extracted schedule information.

Further, the processing unit selects an application program for performing the extracted scheduled job and provides the corresponding application program to the user virtual machine, and the user virtual machine includes a plurality of application programs, and detects and executes a corresponding application programs among the plurality of application programs on the basis of information provided from the processing unit.

Meanwhile, the apparatus for managing a user schedule further includes an authentication unit that performs user authentication for a corresponding user on the basis of user information inputted from the user. At this time, the authentication unit performs authentication of the corresponding user by receiving user profile information from a user authentication terminal in which user authentication information for the user authentication is stored.

Further, the apparatus for managing a user schedule further includes a user information management unit that manages the user authentication information for the user authentication.

Meanwhile, in order to achieve the object, according to another aspect of the present invention, a method for managing a user schedule that manages a schedule of a user by receiving schedule information from a schedule management server includes: collecting schedule information of a corresponding user from the schedule management server while access of the user and extracting information on a schedule to be performed among the collected schedule information; determining a work environment for performing the corresponding scheduled job from the extracted schedule information and allocating resources in accordance with the determined work environment; and creating a user virtual machine for performing the scheduled job of the corresponding user in the work environment formed by using the allocated resources.

Further, the method for managing a user schedule further includes selecting an application program for performing the extracted scheduled job and providing the corresponding application program to a virtual machine.

Meanwhile, the method for managing a user schedule further includes, before collecting the schedule information of the user, performing authentication of the user on the basis of user authentication information provided from the user.

According to an embodiment of the present invention, even though a user does not perform an additional action, registered schedule information can be automatically provided by collecting user's schedule information and extracting a job which a corresponding user must perform.

Further, when a schedule of the corresponding user is performed, a work environment of the performed scheduled job is determined and resources are automatically allocated, such that the user scheduled job is performed through the virtual machine of the computing environment that will perform the corresponding work. Therefore, since the user needs not to set computing resources through a complicated process in order to perform the corresponding scheduled job, user convenience is increased.

In addition, as an application program for performing the corresponding work in the created virtual machine is automatically executed, user convenience is increased by performing the corresponding scheduled job. The user scheduled job can continuously be performed by dynamically creating the virtual machine depending on a work environment of the scheduled job to be performed.

### BRIEF DESCRIPTION OF THE DRAWINGS

FIG. 1 is a block diagram for illustrating a configuration of an apparatus of managing a user schedule according to an embodiment of the present invention;

FIG. 2 is a block diagram illustrating a configuration of a manager virtual machine adopted in an apparatus for managing a user schedule according to an embodiment of the present invention;

FIG. 3 is a block diagram illustrating a configuration of a schedule management server adopted in an apparatus for managing a user schedule according to an embodiment of the present invention;

FIG. 4 is a block diagram illustrating a configuration of a user virtual machine adopted in an apparatus for managing a user schedule according to an embodiment of the present invention; and

FIGS. 5 to 6 are flowcharts illustrating an operation flow of a method for managing a user schedule according to an exemplary embodiment.

### DETAILED DESCRIPTION OF THE PREFERRED EMBODIMENTS

Hereinafter, embodiments of the present invention will be described with reference to the accompanying drawings.

The present invention relates to an apparatus for managing a user schedule by executing an application program through a user virtual machine dynamically created by a manager virtual machine on a user terminal having the manager virtual machine.

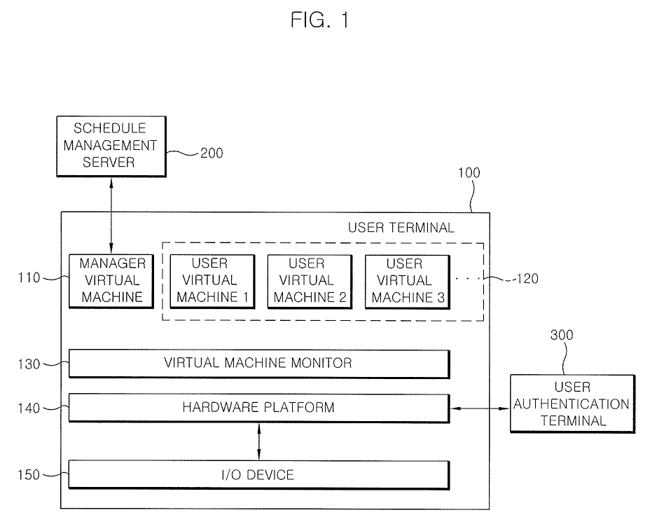

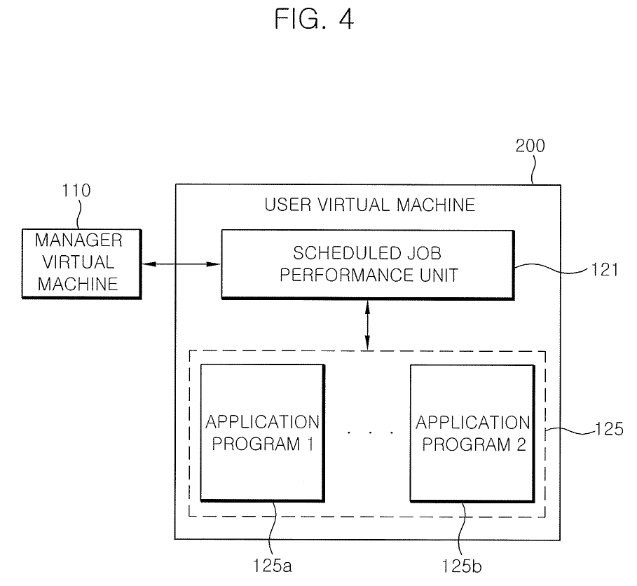

FIGS. 1 and 4 are diagrams for illustrating a configuration of an apparatus for managing a user schedule according to an embodiment of the present invention. First, FIG. 1 illustrates an entire configuration of the apparatus for managing a user schedule according to an embodiment of the present invention.

Referring to FIG. 1, the apparatus for managing a user schedule according to the embodiment of the present invention includes a manager virtual machine 110, a user virtual machine 120, and a schedule management server 200.

At this time, the manager virtual machine 110 and the user virtual machine 120 are implemented in a user terminal 100 and serves to schedule a Java application program in link with the schedule management server 200 that manages a general task such as the user schedule, etc.

Herein, the manager virtual machine 110 creates the user virtual machine 120 for performing a corresponding scheduled job on the basis of information on the user schedule and allocates resources such as a CPU, a memory, an input/output device 150, etc. of the user virtual machine 120 depending on a work environment of the corresponding schedule. Further, the user virtual machine 120 is dynamically created by the manager virtual machine 110 and allows a user to perform the corresponding scheduled job by executing an application program corresponding to the task such as the user schedule, etc. At this time, the manager virtual machine 110 manages a life cycle of the user virtual machine 120.

At this time, the user terminal 100 includes a virtual machine monitor (VMM) 130 and is implemented by the virtual machine monitor 130 while calling the manager virtual machine 110 or the user virtual machine 120. In addition, the user terminal 100 houses a platform for a basic hardware device of the user terminal 100. At this time, a plurality of input/output devices 150 that are connected to a hardware platform 140 are used as an input/output resource.

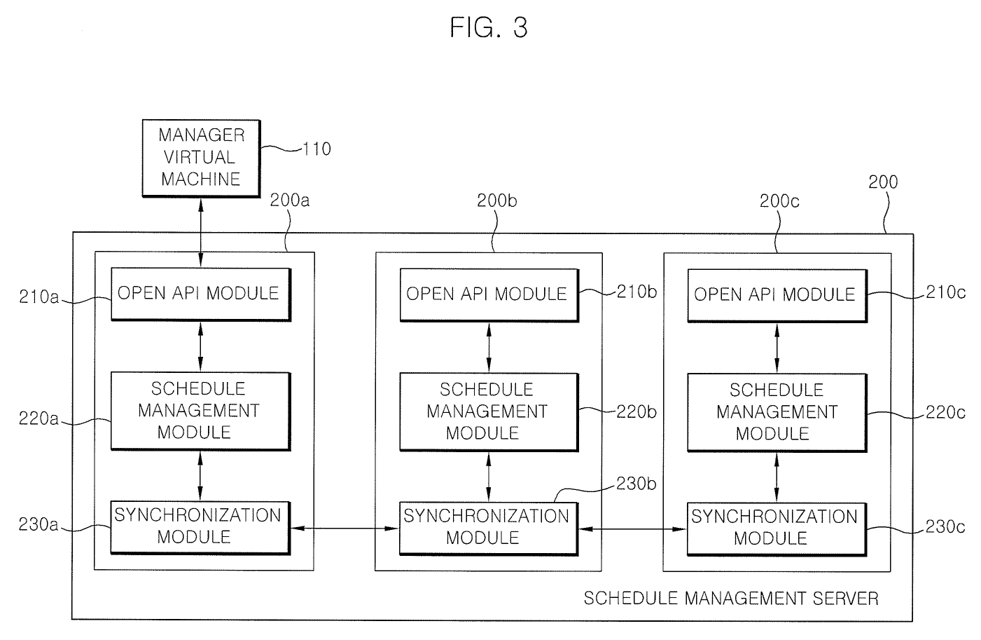

The schedule management server 200 is linked with a plurality of schedule management programs such as a Google calendar, an Outlook, a Thunderbird, etc. The schedule management programs synchronize schedule information each other through a synchronization module. Therefore, the manager virtual machine 110 collects schedule information of a corresponding user through an open API provided from the plurality of schedule management programs by accessing the schedule management server 200. A detailed configuration of the schedule management server 200 will be described with reference to FIG. 3.

Meanwhile, the apparatus for managing a user schedule according to the embodiment of the present invention further includes a user authentication terminal 300 that provides user authentication information for user authentication in the manager virtual machine 110. Herein, user profile information for user authentication and device profile information of the user authentication terminal 300 are stored in the user authentication terminal 300 and the user authentication terminal 300 provides the stored user profile information and device profile information while being connected to the user terminal 100 in a wired or wireless method to the manager virtual machine 110.

Therefore, the manager virtual machine 110 performs the user authentication on the basis of the user profile information and the device profile information that are provided from the user authentication terminal 300. Of course, in addition to the user authentication terminal 300, a method of performing the user authentication such as a method of performing the user authentication on the basis of information inputted by the user is not limited to any one method.

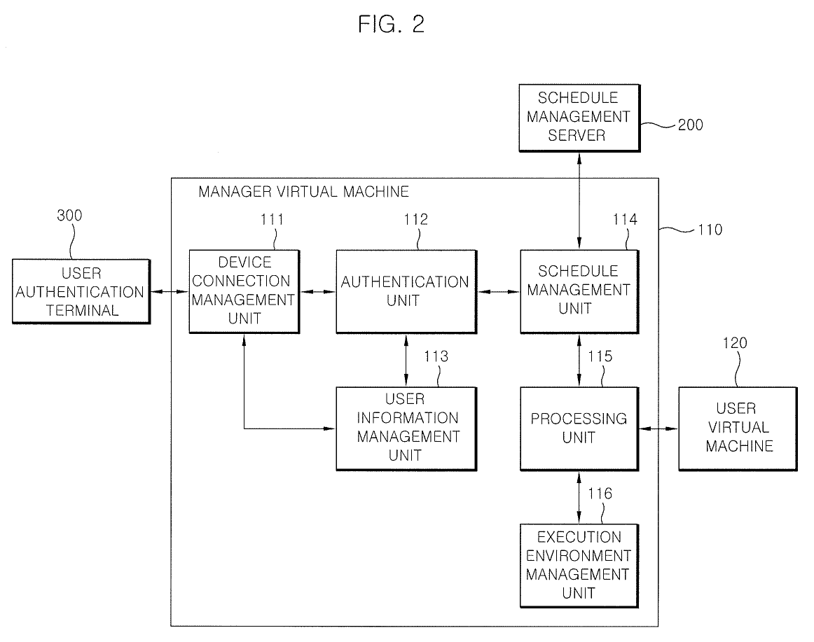

FIG. 2 is a block diagram of a configuration of a manager virtual machine according to an embodiment of the present invention. Referring to FIG. 2C, the manager virtual machine 110 includes a device connection management unit 111, an authentication unit 112, a user information management unit 113, a schedule management unit 114, a processing unit 115, and an execution environment management unit 116.

The device connection management unit 111, as a means for managing connection with the user authentication terminal 300, receives the user profile information and the device profile information from the user authentication terminal 300 when being connected with the user authentication terminal 300. Further, the device connection management unit 111 transfers the user profile information and the device profile information that are received from the user authentication terminal 300 to the authentication unit 112 and the user information management unit 113.

The authentication unit 112, as a means for performing the user authentication in order to provide the schedule information to the corresponding user, performs the user authentication on the basis of user authentication information inputted from the device connection management unit 111 and the user. Further, the authentication unit 112 notifies that authentication of the corresponding user is completed to the schedule management unit 114 when the user authentication of the corresponding user is completed.

When the user authentication of the corresponding user is completed by the authentication unit 112, the schedule management unit 114 accesses the schedule management server 200 and provides the corresponding user information and receives predetermined schedule information of the corresponding user from the schedule management server 200. Further, the schedule management unit 114 extracts a desired schedule in the schedule information provided from the schedule management server 200 and provides the desired schedule to the processing unit 115. Herein, the schedule management unit 114 basically extracts a scheduled job to be next performed on the basis of a current time, but is not limited thereto and may be changed in accordance with setting.

The processing unit 115 reads the schedule information extracted by the schedule management unit 114 to acquire relevant information. In other words, the processing unit 115 reads the schedule information to acquire information such as a scheduled job performance content, a scheduled job performance start timing, a scheduled job performance end timing, a scheduled job performance place, etc. Further, the processing unit 115 acquires work environment information for performing an additional scheduled job. Herein, the work environment information for performing the scheduled job includes a work type, software information for performing the scheduled job, resource information for executing software, etc.

The execution environment management unit 116 creates the user virtual machine 120 by allocating the resource on the basis of the information acquired by the processing unit 115. For example, when a work type of a scheduled job to be performed is a document work, the execution environment management unit 116 calls a virtual machine setting option basically defined for the document work and allocates resources such as a CPU, a memory, a mouse, a keyboard, a monitor, etc. to create the user virtual machine 120 for the document work. Meanwhile, when the work type is web-browsing, the execution environment management unit 116 calls a virtual machine setting option basically defined for the web-browsing and allocates the resources such as the CPU, the memory, the mouse, the keyboard, the monitor, etc. to create the user virtual machine for the web-browsing.

If the work type is not defined, a user interface which can be set at the time of configuring the user virtual machine 120 is displayed and presentation which can directly be selected by the user is provided. When user selection is completed, the user virtual machine 120 is created by allocating the resource on the basis of corresponding information.

Herein, a work of which type can be differentiated can be created, edited, and deleted with a document having a format created by the manager virtual machine 110. Therefore, the manager virtual machine 110 can define various work type and has different virtual machine creation options with respect to a newly defined work type.

Further, the execution environment management unit 116 detects information of an application program which must be executed in order perform the corresponding scheduled job and transfers the application program information to the user virtual machine 120 through the processing unit 115.

FIG. 3 is a block diagram of a configuration of a schedule management server according to an embodiment of the present invention. Referring to FIG. 3, the schedule management server 200 includes a plurality of schedule management programs 200a, 200b, and 220c, as described above. Herein, the schedule management programs 200a, 200b, and 200c include open API modules 210a, 210b, and 210c, schedule management modules 220a, 220b, and 220c, and synchronization modules 230a, 230b, and 230c, respectively.

The open API modules 210a, 210b, and 210c support connection with the manager virtual machine 110. The schedule management modules 220a, 220b, and 220c store schedule information for each user and serves to manage the stored schedule information. If the manager virtual machine 110 calls schedule information of a predetermined user, the schedule management modules 220a, 220b, and 220c extract the schedule information of the corresponding user and provides the schedule information to the manager virtual machine 110 through the open API modules 210, 210b, and 210c. The synchronization modules 230a, 230b, and 230c are connected to each other at a predetermined cycle and share the schedule information for each user stored in the corresponding schedule management programs 200a, 200b, and 200c each other to be synchronized.

Therefore, when the manager virtual machine 110 accesses any one schedule management program, the manager virtual machine 110 can provide schedule information provided from the other schedule management programs through the corresponding schedule management program.

FIG. 4 is a block diagram of a configuration of a user virtual machine according to an embodiment of the present invention.

Referring to FIG. 4, the user virtual machine 120 includes a plurality of application programs 125a and 125b for performing the user scheduled job. At this time, a scheduled job performance unit 121 of the user virtual machine 120 detects and executes a corresponding application program from information of an application program provided from the manager virtual machine 110. Further, the scheduled job performance unit 121 receives a predetermined control command from the user and performs a work corresponding to the control command inputted from the user on the executed application program.

The above-configured operation of the present invention will now be described.

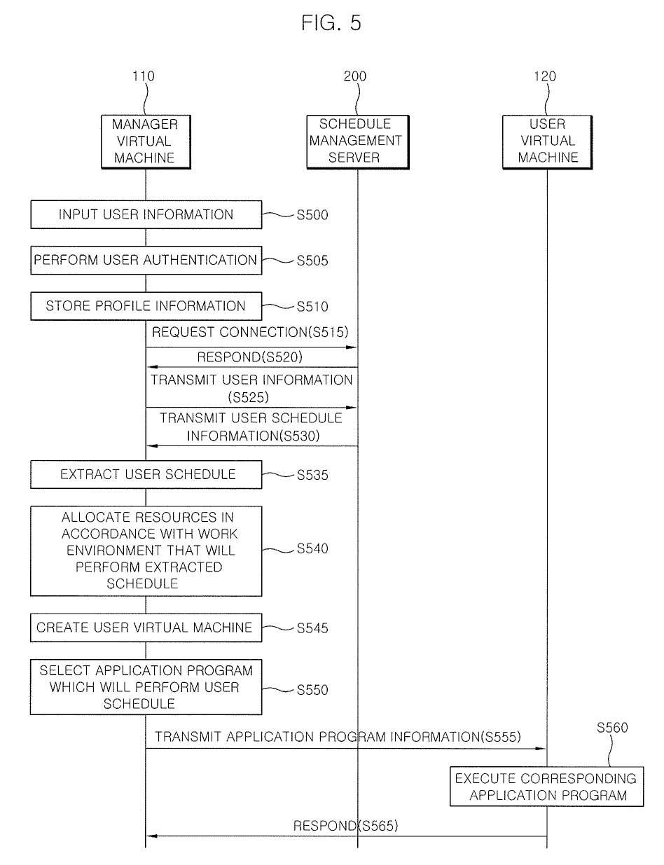

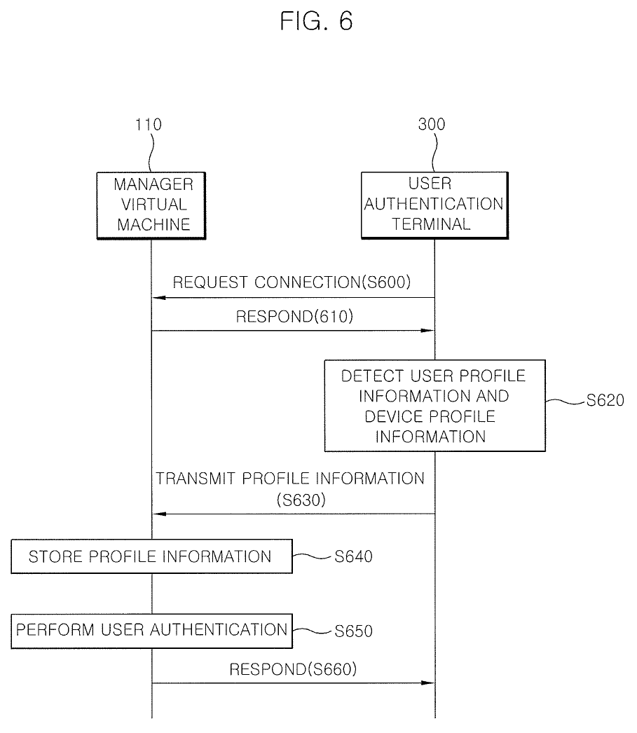

FIGS. 5 to 6 are flowcharts illustrating an operation flow of a method for managing a user schedule according to an embodiment of the present invention.

First, FIG. 5 illustrates an overall flow of the method for managing a user schedule according to the embodiment of the present invention. When a manager virtual machine 110 receives user information (S500), the manager virtual machine 110 performs user authentication by using the inputted user information (S505) and stores user authentication information (S510).

In addition, when the user authentication is completed, the manager virtual machine 110 requests connection to a schedule management server 200 of the schedule management server 200 (S515) and when the manager virtual machine 110 receives a response signal from the schedule management server 200, the manager virtual machine 110 is connected to the schedule management server 200 when receiving a response signal from the schedule management server 200 (S520). When the manager virtual machine 110 is connected to the schedule management server 200, the manager virtual machine 110 transmits the authenticated user information (S525) and the schedule management server 200 detects user schedule information corresponding to the user information transmitted from the manager virtual machine 110 and transmits the user schedule information to the manager virtual machine 110 (S530).

The manager virtual machine 110 extracts a scheduled job to be performed on the basis of a current time from the schedule information of the corresponding user, which is provided from the schedule management server 200 (S535). At this time, the manager virtual machine 110 analyzes the extracted schedule information to acquire information on a scheduled job performance content, scheduled job start and stop timings, a work type, a resource path, etc. Therefore, the manager virtual machine 110 determines a work environment for performing the corresponding scheduled job on the basis of the acquired information, allocates resources in accordance with the determined resource environment (S540), and creates a user virtual machine 120 of the work environment which will perform the corresponding scheduled job (S545).

Lastly, the manager virtual machine 110 selects an application program for performing the corresponding scheduled job in the user virtual machine 120 (S550) and transmits the corresponding information to the created user virtual machine 120 (S555). The corresponding user virtual machine 120 extracts and executes an application program corresponding to the application program information transmitted from the manager virtual machine 110 (S560) and transmits a response signal to the manager virtual machine 110 (S565).

Meanwhile, FIG. 6 is a flowchart illustrating a method of acquiring user authentication information according to an embodiment of the present invention and illustrates an operation of acquiring the user authentication information through a user authentication terminal 300.

Referring to FIG. 6, the user authentication terminal 300 requests connection to the user terminal 100 of the manager virtual machine 110 when the user authentication terminal 300 is connected to the user terminal 100 in a wired or wireless method. At this time, the manager virtual machine 110 responds to the request, such that the manager virtual machine 110 and the user authentication terminal 300 are connected to each other.

At this time, the user authentication terminal 300 detects stored user profile information and device profile information (S620) and transmits the detected profile information to the manager virtual machine 110 for the user authentication in the manager virtual machine 110.

Therefore, the manager virtual machine 110 stores the profile information provided from the user authentication terminal 300 (S640) and performs the user authentication on the basis of the stored profile information (S650). When the user authentication of the corresponding user is completed, a response signal is transmitted to the user authentication terminal 300 (S660). If the user authentication is failed, the authentication information of the corresponding user may be requested to the user authentication terminal 300 again.

As described above, according to an embodiment of the present invention, in an apparatus and a method for managing a user schedule, the configuration and method of the embodiments described as above cannot be limitatively adopted, but the embodiments may be configured by selectively combining all the embodiments or some of the embodiments so that various modifications can be made.

What is claimed is:

1. An apparatus for managing a user schedule that manages a schedule of a user by receiving schedule information from a schedule management server, comprising:
a schedule management unit that collects schedule information registered with respect to a corresponding user by accessing the schedule management server while access of the user and extracts information on a schedule to be performed;
an execution environment management unit that determines a work environment for performing the corresponding schedule from the extracted schedule information and allocates resources in accordance with the determined work environment; and
a processing unit that creates a user virtual machine for performing the scheduled job of the corresponding user in the work environment formed by using the resources allocated by the execution environment management unit.

2. The apparatus for managing a user schedule according to claim 1, wherein the processing unit dynamically creates the user virtual machine in accordance with work environment determined by the extracted schedule information.

3. The apparatus for managing a user schedule according to claim 1, wherein the processing unit selects an application program for performing the extracted schedule and provides the corresponding application program to the user virtual machine.

4. The apparatus for managing a user schedule according to claim 3, wherein the user virtual machine includes a plurality of application programs, and detects and executes a corresponding application programs among the plurality of application programs on the basis of information provided from the processing unit.

5. The apparatus for managing a user schedule according to claim 1, further comprising:
an authentication unit that performs user authentication for a corresponding user on the basis of user information inputted from the user.

6. The apparatus for managing a user schedule according to claim 5, wherein the authentication unit performs authentication of the corresponding user by receiving user profile information from a user authentication terminal in which user authentication information for the user authentication is stored.

7. The apparatus for managing a user schedule according to claim 1, further comprising:
a user information management unit that manages the user authentication information for the user authentication.

8. A method for managing a user schedule that manages a schedule of a user by receiving schedule information from a schedule management server, comprising:
collecting schedule information of a corresponding user from the schedule management server while access of the user and extracting information on a schedule to be performed among the collected schedule information;
determining a work environment for performing the corresponding scheduled job from the extracted schedule information and allocating resources in accordance with the determined work environment; and
creating a user virtual machine for performing the scheduled job of the corresponding user in the work environment formed by using the allocated resources.

9. The method for managing a user schedule according to claim 8, further comprising:
selecting an application program for performing the extracted scheduled job and providing information on the corresponding application program to a virtual machine.

10. The method for managing a user schedule according to claim 8, further comprising:
before collecting the schedule information of the user, performing authentication of the user on the basis of user authentication information provided from the user.
